(19) United States
(12) Patent Application Publication
(10) Pub. No.: US 2013/0171513 A1
(43) Pub. Date: Jul. 4, 2013

(54) MOLTEN SALT BATTERY

(71) Applicants: Masatoshi Majima, Osaka-shi (JP); Koji Nitta, Osaka-shi (JP); Atsushi Fukunaga, Osaka-shi (JP); Shoichiro Sakai, Osaka-shi (JP); Atsushi Yamaguchi, Osaka-shi (JP); Shinji Inazawa, Osaka-shi (JP)

(72) Inventors: Masatoshi Majima, Osaka-shi (JP); Koji Nitta, Osaka-shi (JP); Atsushi Fukunaga, Osaka-shi (JP); Shoichiro Sakai, Osaka-shi (JP); Atsushi Yamaguchi, Osaka-shi (JP); Shinji Inazawa, Osaka-shi (JP)

(73) Assignee: SUMITOMO ELECTRIC INDUSTRIES, LTD., Osaka-shi, Osaka (JP)

(21) Appl. No.: 13/823,595

(22) PCT Filed: Sep. 27, 2011
(86) PCT No.: PCT/JP2011/071958

§ 371 Date: Mar. 14, 2013

(30) Foreign Application Priority Data
Oct. 21, 2010 (JP) 2010-236822

(51) Int. Cl. H01M 10/39

(52) U.S. Cl. CPC H01M 10/399
USPC 429/188

(57) ABSTRACT

Provided is a molten salt battery whose cycle life is improved by using an electrolyte that is unlikely to cause corrosion of aluminum. In the molten salt battery of the present invention, the total concentration of iron ions and nickel ions contained as impurities in the electrolyte composed of a molten salt is set to be 0.1% by weight or less, preferably 0.01% by weight or less. Because of the low total concentration of iron ions and nickel ions contained in the electrolyte, corrosion of the electrode current collector composed of aluminum is inhibited, and the cycle life of the molten salt battery is improved.

### TECHNICAL FIELD

The present invention relates to a molten salt battery which uses a molten salt as an electrolyte.

### BACKGROUND ART

In recent years, the use of natural energy, such as sunlight or wind power, has been increasing. When electricity is generated using natural energy, the amount of electricity generated tends to vary. Accordingly, in order to supply electric power generated, it is necessary to level the power supply by charging/discharging using a storage battery. Therefore, in order to promote the use of natural energy, storage batteries with high energy density and high efficiency are absolutely necessary. One example of such storage batteries is a sodium-sulfur battery disclosed in PTL 1. Other examples of storage batteries with high density and high efficiency include molten salt batteries.

A molten salt battery is a battery in which a molten salt is used as an electrolyte, and which operates in a state where the molten salt is molten. The operating temperature of the molten salt battery is maintained at a temperature equal to or higher than the melting point of the molten salt, and generally, higher than that of other batteries, such as lithium ion batteries. In conventional lithium ion batteries, an aluminum foil is used as a current collector of a positive electrode, a copper foil is used as a current collector of a negative electrode, and an active material for each electrode is carried on the corresponding current collector. In molten salt batteries, aluminum is used as a material of current collectors for both electrodes in many cases.

### CITATION LIST

### Patent Literature

PTL 1: Japanese Unexamined Patent Application Publication No. 2007-273297

### SUMMARY OF INVENTION

### Technical Problem

When ions of iron or nickel are contained in an electrolyte of a battery, there is a possibility that an aluminum current collector in contact with the electrolyte will be corroded. In lithium ion batteries, corrosion of aluminum is not a major problem. However, in molten salt batteries which have a higher operating temperature than lithium ion batteries and in which aluminum current collectors are used for both electrodes, there is a concern that the current collectors may be degraded by corrosion. In particular, in the case where pitting corrosion occurs in which pits are produced inside the aluminum, the current collectors are likely to be fractured, and the cycle life of the molten salt batteries is shortened.

The present invention has been achieved under the circumstances described above. It is an object of the present invention to provide a molten salt battery whose cycle life is improved by using an electrolyte that is unlikely to cause corrosion of aluminum.

### Solution to Problem

A molten salt battery according to the present invention includes an electrode current collector composed of aluminum, and a molten salt used as an electrolyte, the molten salt battery being characterized in that the total concentration of iron ions and nickel ions contained in the electrolyte is 0.1% by weight or less.

In the present invention, by setting the total concentration of iron ions and nickel ions contained as impurities in the electrolyte of the molten salt battery to be 0.1% by weight or less, corrosion of the electrode current collector composed of aluminum is inhibited.

The molten salt battery according to the present invention may be characterized in that the total concentration of iron ions and nickel ions contained in the electrolyte is 0.05% by weight or less.

Furthermore, in the present invention, by setting the total concentration of iron ions and nickel ions contained as impurities in the electrolyte of the molten salt battery to be 0.05% by weight or less, corrosion of the electrode current collector composed of aluminum is further inhibited.

The molten salt battery according to the present invention may be characterized in that the total concentration of iron ions and nickel ions contained in the electrolyte is 0.01% by weight or less.

Furthermore, in the present invention, by setting the total concentration of iron ions and nickel ions contained as impurities in the electrolyte of the molten salt battery to be 0.01% by weight or less, corrosion of the electrode current collector composed of aluminum is still further inhibited.

### Advantageous Effects of Invention

According to the present invention, corrosion of an electrode current collector composed of aluminum is inhibited, and the cycle life of a molten salt battery is improved. Because of the improvement in the cycle life, the molten salt battery can be used repeatedly, and the present invention exhibits excellent advantageous effects, such as improvement in the practicality of the molten salt battery.

### BRIEF DESCRIPTION OF DRAWINGS

FIG. 1 is a schematic cross-sectional view showing an example of a configuration of a molten salt battery of the present invention.

FIG. 2 is a schematic cross-sectional view showing a positive electrode current collector in which pitting corrosion has occurred.

FIG. 3 is a table showing the relationship between the total concentration of iron ions and nickel ions contained in an electrolyte of a molten salt battery and the cycle life of the molten salt battery.

### DESCRIPTION OF EMBODIMENTS

The present invention will be specifically described below with reference to the drawings which show the embodiments of the invention.

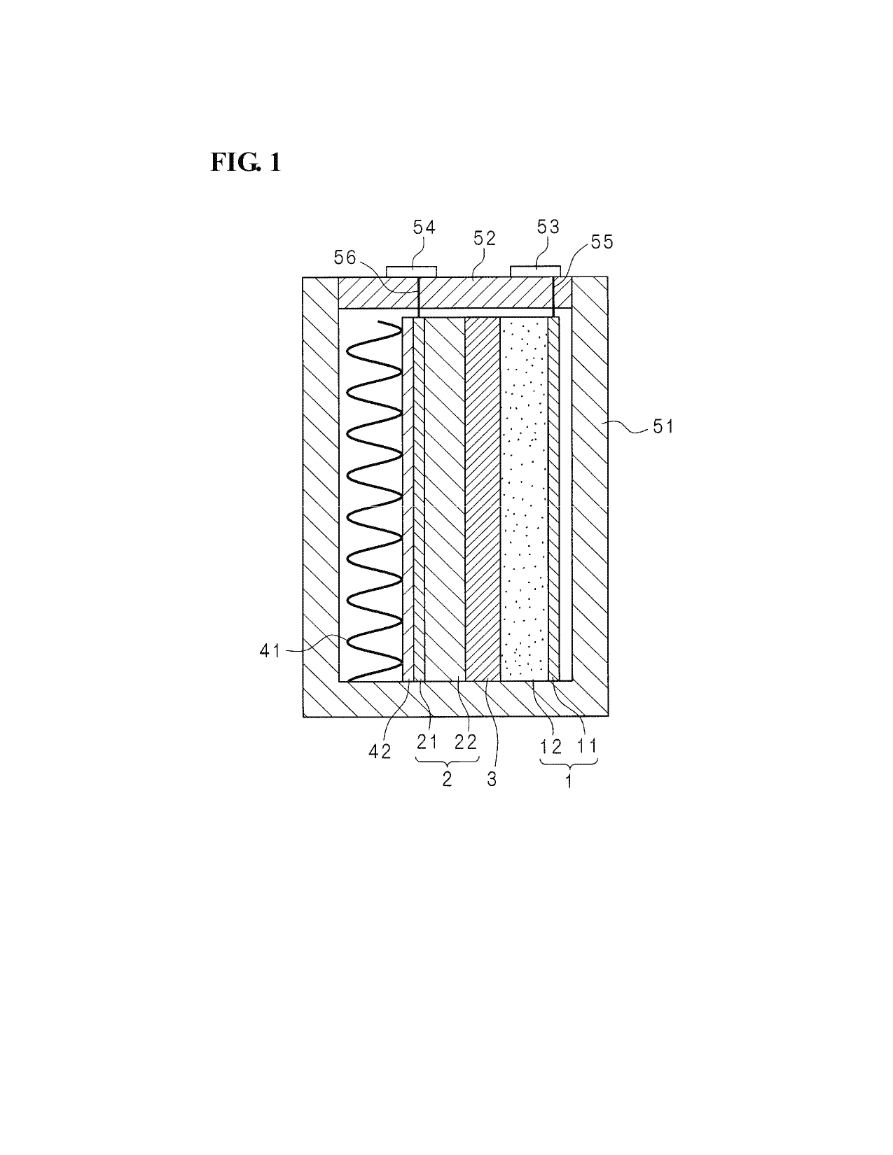

FIG. 1 is a schematic cross-sectional view showing an example of a configuration of a molten salt battery of the present invention. A schematic cross-sectional view longitudinally taken through the molten salt battery is shown in FIG. 1. The molten salt battery is configured such that a positive electrode 1, a separator 3, and a negative electrode 2 are placed side by side in a rectangular parallelepiped box-like battery case 51 with an open top face, and the battery case 51 is capped with a lid member 52. The battery case 51 and the lid member 52 are composed of aluminum. The positive electrode 1 and the negative electrode 2 are each shaped like a rectangular plate, and the separator 3 is shaped like a sheet. The separator 3 is interposed between the positive electrode 1 and the negative electrode 2. The positive electrode 1, the separator 3, and the negative electrode 2 are stacked and placed longitudinally on the bottom face of the battery case 51.

A spring 41 made of a corrugated metal sheet is disposed between the negative electrode 2 and an inner wall of the battery case 51. The spring 41 urges a non-flexible flat pressure plate 42 composed of an aluminum alloy to press the negative electrode 2 toward the separator 3 and the positive electrode 1. The positive electrode 1 is pressed, by the reaction of the spring 41, from an inner wall on the side opposite the spring 41 toward the separator 3 and the negative electrode 2. The spring 41 is not limited to a metal spring or the like, and may be an elastic body, such as one made of rubber. When the positive electrode 1 or the negative electrode 2 is expanded or contracted by charging and discharging, the volume change of the positive electrode 1 or the negative electrode 2 is absorbed by expansion and contraction of the spring 41.

The positive electrode 1 is formed by applying a positive electrode material 12 containing a positive electrode active material, such as NaCrO₂, and a binder onto a rectangular plate-shaped positive electrode current collector 11 composed of aluminum. Note that the positive electrode active material is not limited to NaCrO₂. The negative electrode 2 is formed by plating a rectangular plate-shaped negative electrode current collector 21 composed of aluminum with a negative electrode material 22 containing a negative electrode active material, such as tin. When the negative electrode current collector 21 is plated with the negative electrode material 22, after performing zincate treatment in which a zinc underlayer is formed by plating, tin plating is performed. The negative electrode active material is not limited to tin, and for example, tin may be replaced with metallic sodium, carbon, silicon, or indium. The negative electrode material 22 may be formed, for example, by incorporating a binder in powder of the negative electrode active material and applying the resulting mixture onto the negative electrode current collector 21.

The separator 3 is composed of an insulating material, such as silicate glass or a resin, and is configured such that an electrolyte can be retained therein and sodium ions can pass therethrough. The separator 3 is, for example, composed of glass cloth or a resin formed into a porous shape.

In the battery case 51, the positive electrode material 12 of the positive electrode 1 and the negative electrode material 22 of the negative electrode 2 are placed so as to face each other, and the separator 3 is interposed between the positive electrode 1 and the negative electrode 2. The separator 3 is impregnated with an electrolyte composed of a molten salt. The electrolyte impregnated in the separator 3 is in contact with the positive electrode material 12 of the positive electrode 1 and the negative electrode material 22 of the negative electrode 2. The inner surface of the battery case 51 has an insulating structure by means of coating with an insulating resin or the like in order to prevent short-circuiting between the positive electrode 1 and the negative electrode 2. A positive electrode terminal 53 and a negative electrode terminal 54 for external connection are provided on the outside of the lid member 52. The positive electrode terminal 53 and the negative electrode terminal 54 are insulated from each other, and a part of the lid member 52 facing the inside of the battery case 51 is also insulated by an insulating film or the like. An end of the positive electrode current collector 11 is connected to the positive electrode terminal 53 by a lead 55, and an end of the negative electrode current collector 21 is connected to the negative electrode terminal 54 by a lead 56. The lead 55 and the lead 56 are insulated from the lid member 52. The lid member 52 is capped on the battery case 51 by welding.

The electrolyte impregnated in the separator 3 is a molten salt that is a conductive liquid in a molten state.

At a temperature equal to or higher than the melting point of the molten salt, the molten salt becomes an electrolytic solution, and the molten salt battery operates as a secondary battery. In order to decrease the melting point, the electrolyte is preferably prepared by mixing a plurality of molten salts. For example, the electrolyte is a mixed salt of NaFSA in which a sodium ion is a cation and bis(fluorosulfonyl)amide (FSA) is an anion and KFSA in which a potassium ion is a cation and FSA is an anion. The configuration of the molten salt battery shown in FIG. 1 is schematic only. The molten salt battery may contain other components (not shown), such as a heater which heats the inside of the battery and a temperature sensor. FIG. 1 shows the configuration which includes a pair of a positive electrode 1 and a negative electrode 2. However, in the molten salt of the present invention, a configuration may be used in which a plurality of positive electrodes 1 and a plurality of negative electrodes 2 are alternately stacked with a separator 3 therebetween.

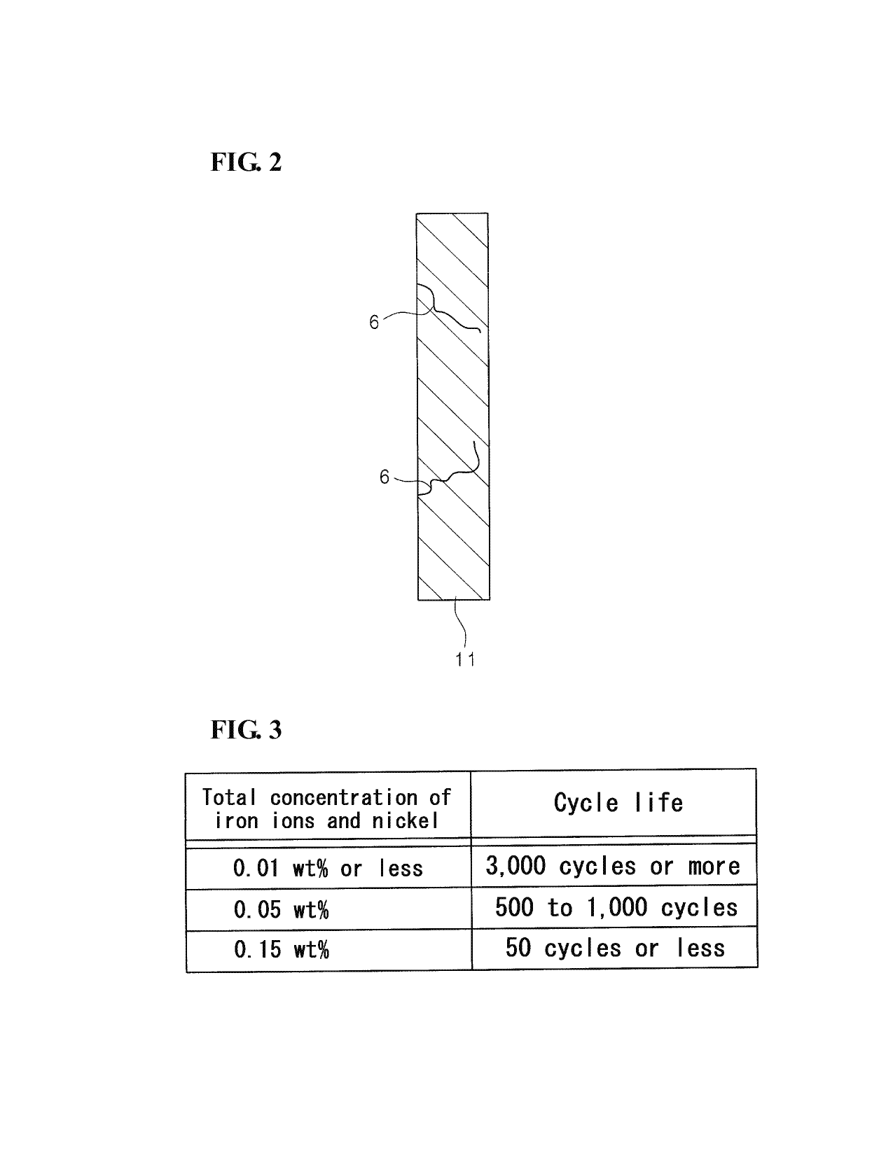

When the electrolyte contains iron ions or nickel ions, aluminum in contact therewith is corroded. That is, the positive electrode current collector 11 and the negative electrode current collector 21, each composed of aluminum, in contact with the electrolyte are corroded. In the case where the positive electrode current collector 11 and the negative electrode current collector 21 are corroded uniformly as a whole, few problems are posed. However, in the case where pitting corrosion occurs in which pits are produced inside the electrode current collectors, the positive electrode current collector 11 and the negative electrode current collector 21 are likely to be fractured. FIG. 2 is a schematic cross-sectional view showing a positive electrode current collector 11 in which pitting corrosion has occurred. In FIG. 2, reference sign 6 denotes a pitting corrosion portion. As corrosion progresses, the pitting corrosion portion 6 extends from the part in contact with the electrolyte toward the inside of the positive electrode current collector 11. After pitting corrosion has extended to the inside of the positive electrode current collector 11 to a certain extent, the positive electrode current collector 11 easily fractures upon impact. In the same manner, pitting corrosion also occurs in the negative electrode current collector 21. In a molten salt battery, since the internal temperature during operation is higher than that in other batteries, such as a lithium ion battery, pitting corrosion is likely to occur. In the molten salt battery having an electrolyte containing iron ions or nickel irons, the positive electrode current collector 11 and the negative electrode current collector 21 are degraded and likely to be fractured by the occurrence of corrosion, and the cycle life is shortened. Therefore, it is desirable that the concentrations of iron ions and nickel ions contained in the molten salt be as low as possible. In the molten salt battery of the present invention, by decreasing the concentrations of iron ions and nickel irons contained as impurities in the electrolyte, the cycle life is improved.

FIG. 3 is a table showing the relationship between the total concentration of iron ions and nickel ions contained in an electrolyte of a molten salt battery and the cycle life of the molten salt battery. FIG. 3 shows the results obtained by measuring the cycle life of the molten salt battery in which the total concentration of iron ions and nickel ions contained as impurities in the electrolyte is adjusted. As shown in FIG. 3, when the total concentration of iron irons and nickel ions contained in the electrolyte is 0.15% by weight, the cycle life of the molten salt battery is 50 cycles or less, and thus the practicality of the molten salt battery is low. In order to improve the practicality of the molten salt battery by setting the cycle life at 50 cycles or more, it is necessary to set the total concentration of iron ions and nickel ions contained as impurities in the electrolyte to be at least 0.1% by weight or less.

Furthermore, as shown in FIG. 3, when the total concentration of iron irons and nickel ions contained in the electrolyte is 0.05% by weight, the cycle life of the molten salt battery is 500 to 1,000 cycles. Consequently, in order to improve the practicality of the molten salt battery by setting the cycle life at 500 to 1,000 cycles or more, it is preferable to set the total concentration of iron ions and nickel ions contained as impurities in the electrolyte to be 0.05% by weight or less. Furthermore, as shown in FIG. 3, when the total concentration of iron irons and nickel ions contained in the electrolyte is 0.01% by weight or less, the cycle life of the molten salt battery is 3,000 cycles or more. The molten salt battery with a cycle life of 3,000 cycles or more has sufficient practicality. Consequently, in order to sufficiently improve the practicality of the molten salt battery by setting the cycle life at 3,000 cycles or more, it is preferable to set the total concentration of iron ions and nickel ions contained as impurities in the electrolyte to be 0.01% by weight or less. As is clear from the above description, by setting the total concentration of iron ions and nickel ions contained as impurities in the electrolyte to be 0.1% by weight or less, preferably 0.01% or less, corrosion of the positive electrode current collector 11 and the negative electrode current collector 21, each composed of aluminum, is inhibited, and the cycle life of the molten salt battery is improved. Because of the improvement in the cycle life, the molten salt battery can be used repeatedly, and the practicality of the molten salt battery is improved.

### REFERENCE SIGNS LIST

1 positive electrode
11 positive electrode current collector
2 negative electrode
21 negative electrode current collector
3 separator
41 spring
51 battery case
52 lid member
6 pitting corrosion portion

1. A molten salt battery comprising an electrode current collector composed of aluminum, and a molten salt used as an electrolyte, the molten salt battery being characterized in that the total concentration of iron ions and nickel ions contained in the electrolyte is 0.1% by weight or less.

2. The molten salt battery according to claim 1, characterized in that the total concentration of iron ions and nickel ions contained in the electrolyte is 0.05% by weight or less.

3. The molten salt battery according to claim 2, characterized in that the total concentration of iron ions and nickel ions contained in the electrolyte is 0.01% by weight or less.
